(19) United States
(12) Patent Application Publication
(10) Pub. No.: US 2019/0310821 A1
(43) Pub. Date: Oct. 10, 2019

(54) EZVolumeTV

(71) Applicant: Pamela C. Hildebrandt, Woodside, CA (US)

(72) Inventor: Pamela C. Hildebrandt, Woodside, CA (US)

(21) Appl. No.: 15/998,239

(22) Filed: Apr. 6, 2018

(51) Int. Cl. G06F 3/16; H04R 29/00

(52) U.S. Cl. CPC G06F 3/165; H04R 2430/01; H04R 29/001

(57) ABSTRACT

The invention solves the basic problem presented by television shows and movies, where there are often very low volume portions which are somewhat hard to hear (e.g. conversations, quiet and suspenseful portions of entertainment) and portions of the entertainment that are very loud (explosions, chase scenes, gun fights, screaming moments, etc.). It has become a common technique in modern film and TV production to establish significant swings in volume where the viewer is forced to listen closely to quiet scenes, then be shocked by explosions, gun fights, and other very loud portions of the show.

The invention provides a toggled audio volume button, whereby the desired high volume setting and low volume settings are pre-set by the listener, and can be toggled between. In this manner, the high volume setting can be selected for quiet scenes, and the low volume setting can be selected for noisy scenes.

### CROSS REFERENCES TO RELATED PATENT APPLICATIONS

Media content output control

| | | |
|---|---|---|
| 9,936,248 | Mountain, Dale Llewelyn (Echostar) | Apr. 3, 2018 |

Other references cited:

U.S. Patent Documents

| | | |
|---|---|---|
| 6,005,562 | December 1999 | Shiga et al. |
| 6,177,931 | January 2001 | Alexander et al. |
| 6,529,230 | March 2003 | Chong |
| 6,681,396 | January 2004 | Bates et al. |
| 6,774,924 | August 2004 | Kato et al. |
| 7,174,512 | February 2007 | Martin et al. |
| 7,197,715 | March 2007 | Valeria |
| 7,633,887 | December 2009 | Panwar et al. |
| 7,680,894 | March 2010 | Diot et al. |
| 7,774,811 | August 2010 | Poslinski et al. |
| 7,818,368 | October 2010 | Yang et al. |
| 7,825,989 | November 2010 | Greenberg |
| 7,849,487 | December 2010 | Vosseller |
| 8,024,753 | September 2011 | Kummer |
| 8,046,798 | October 2011 | Schlack et al. |
| 8,079,052 | December 2011 | Chen et al. |
| 8,104,065 | January 2012 | Aaby et al. |
| 8,209,713 | June 2012 | Lai et al. |
| 8,296,797 | October 2012 | Olstad et al. |
| 8,312,486 | November 2012 | Briggs et al. |
| 8,424,041 | April 2013 | Candelore et al. |
| 8,427,356 | April 2013 | Satish |
| 8,627,349 | January 2014 | Kirby et al. |
| 8,667,527 | March 2014 | Yan et al. |
| 8,689,258 | April 2014 | Kemp |
| 8,752,084 | June 2014 | Lai et al. |
| 8,855,681 | October 2014 | George et al. |
| 8,973,038 | March 2015 | Gratton |
| 8,973,068 | March 2015 | Kotecha et al. |
| 8,990,418 | March 2015 | Bragg |
| 9,038,127 | May 2015 | Hastings et al. |
| 9,066,156 | June 2015 | Kapa |
| 9,213,986 | December 2015 | Buchheit |
| 9,253,533 | February 2016 | Morgan et al. |
| 9,264,779 | February 2016 | Kirby et al. |
| 9,420,333 | August 2016 | Martch et al. |
| 9,426,516 | August 2016 | Kemp |
| 9,565,474 | February 2017 | Petruzzelli et al. |
| 9,602,875 | March 2017 | Hussain |
| 9,609,379 | March 2017 | Martch et al. |
| 9,621,959 | April 2017 | Mountain |
| 9,681,176 | June 2017 | Mountain |
| 9,681,196 | June 2017 | Mountain |
| 2001/0013123 | August 2001 | Freeman et al. |
| 2001/0026609 | October 2001 | Weinstein et al. |
| 2002/0059610 | May 2002 | Ellis |
| 2002/0067376 | June 2002 | Martin et al. |
| 2002/0075402 | June 2002 | Robson et al. |
| 2002/0164155 | November 2002 | Mate |
| 2002/0174430 | November 2002 | Ellis et al. |
| 2002/0178444 | November 2002 | Trajkovic et al. |
| 2003/0023742 | January 2003 | Allen et al. |
| 2003/0056220 | March 2003 | Thornton |
| 2003/0066076 | April 2003 | Minahan |
| 2003/0066077 | April 2003 | Gutta et al. |
| 2003/0118014 | June 2003 | Iyer et al. |
| 2003/0126605 | July 2003 | Betz et al. |
| 2003/0126606 | July 2003 | Buczak et al. |
| 2003/0154485 | August 2003 | Johnson et al. |
| 2003/0188317 | October 2003 | Liew et al. |
| 2003/0189674 | October 2003 | Inoue et al. |
| 2003/0208763 | November 2003 | McElhatten et al. |
| 2003/0229899 | December 2003 | Thompson et al. |
| 2004/0019489 | January 2004 | Funk et al. |
| 2004/0181807 | September 2004 | Theiste et al. |
| 2005/0030977 | February 2005 | Casey et al. |
| 2005/0044570 | February 2005 | Poslinski |
| 2005/0071865 | March 2005 | Martins |
| 2005/0125302 | June 2005 | Brown et al. |
| 2005/0152565 | July 2005 | Jouppi |
| 2005/0166230 | July 2005 | Gaydou et al. |
| 2005/0180568 | August 2005 | Krause |
| 2005/0191041 | September 2005 | Braun |
| 2005/0240961 | October 2005 | Jerding et al. |
| 2005/0264705 | December 2005 | Kitamura |
| 2005/0275758 | December 2005 | McEvilly et al. |
| 2006/0020962 | January 2006 | Stark et al. |
| 2006/0085828 | April 2006 | Dureau et al. |
| 2006/0089870 | April 2006 | Myhr |
| 2006/0174277 | August 2006 | Sezan et al. |
| 2006/0190615 | August 2006 | Panwar et al. |
| 2006/0238656 | October 2006 | Chen et al. |
| 2006/0253581 | November 2006 | Dixon et al. |
| 2006/0282852 | December 2006 | Purpura et al. |
| 2006/0282869 | December 2006 | Plourde, Jr. |
| 2007/0033616 | February 2007 | Gutta |
| 2007/0058930 | March 2007 | Iwamoto |
| 2007/0083901 | April 2007 | Bond |
| 2007/0127894 | June 2007 | Ando et al. |
| 2007/0146554 | June 2007 | Strickland et al. |
| 2007/0154163 | July 2007 | Cordray |
| 2007/0154169 | July 2007 | Cordray et al. |
| 2007/0157235 | July 2007 | Teunissen |
| 2007/0157249 | July 2007 | Cordray et al. |
| 2007/0157253 | July 2007 | Ellis et al. |
| 2007/0157281 | July 2007 | Ellis et al. |
| 2007/0188655 | August 2007 | Ohta |
| 2007/0199040 | August 2007 | Kates |
| 2007/0204302 | August 2007 | Calzone |
| 2007/0226766 | September 2007 | Poslinski et al. |
| 2007/0245379 | October 2007 | Agnihortri |
| 2008/0022012 | January 2008 | Wang |
| 2008/0060006 | March 2008 | Shanks et al. |
| 2008/0086743 | April 2008 | Cheng et al. |
| 2008/0097949 | April 2008 | Kelly et al. |
| 2008/0109307 | May 2008 | Ullah |
| 2008/0123825 | May 2008 | Abramson et al. |
| 2008/0134043 | June 2008 | Georgis et al. |
| 2008/0163305 | July 2008 | Johnson et al. |
| 2008/0195457 | August 2008 | Sherman et al. |
| 2008/0235348 | September 2008 | Dasgupta |
| 2008/0239169 | October 2008 | Moon et al. |
| 2008/0282312 | November 2008 | Blinnikka |
| 2008/0300982 | December 2008 | Larson et al. |
| 2008/0305832 | December 2008 | Greenberg |
| 2008/0320523 | December 2008 | Morris et al. |
| 2009/0044217 | February 2009 | Lutterbach et al. |
| 2009/0055385 | February 2009 | Jeon et al. |
| 2009/0102984 | April 2009 | Arling et al. |
| 2009/0138902 | May 2009 | Kamen |
| 2009/0150941 | June 2009 | Riedl et al. |
| 2009/0178071 | July 2009 | Whitehead |
| 2009/0234828 | September 2009 | Tu |
| 2009/0249412 | October 2009 | Bhogal et al. |
| 2009/0276803 | November 2009 | Weaver |
| 2009/0282445 | November 2009 | Yang et al. |
| 2009/0293093 | November 2009 | Igarashi |
| 2009/0299824 | December 2009 | Barnes, Jr. |
| 2009/0325523 | December 2009 | Choi |
| 2010/0031306 | February 2010 | Pandey |
| 2010/0040151 | February 2010 | Garrett |
| 2010/0071007 | March 2010 | Meijer |
| 2010/0071062 | March 2010 | Choyi et al. |
| 2010/0083327 | April 2010 | Toba et al. |
| 2010/0089996 | April 2010 | Koplar |
| 2010/0115554 | May 2010 | Drouet et al. |
| 2010/0122294 | May 2010 | Craner |
| 2010/0146560 | June 2010 | Bonfrer |
| 2010/0153983 | June 2010 | Phillmon et al. |
| 2010/0153999 | June 2010 | Yates |
| 2010/0158479 | June 2010 | Craner |
| 2010/0166389 | July 2010 | Knee et al. |
| 2010/0169925 | July 2010 | Takegoshi |
| 2010/0218214 | August 2010 | Fan et al. |
| 2010/0251295 | September 2010 | Amento et al. |
| 2010/0262986 | October 2010 | Adimatyam et al. |
| 2010/0269144 | October 2010 | Forsman et al. |
| 2010/0319019 | December 2010 | Zazza |
| 2010/0322592 | December 2010 | Casagrande |
| 2010/0333131 | December 2010 | Parker et al. |
| 2011/0016492 | January 2011 | Morita |
| 2011/0019839 | January 2011 | Nandury |
| 2011/0030016 | February 2011 | Pino et al. |
| 2011/0052156 | March 2011 | Kuhn |
| 2011/0072448 | March 2011 | Stiers et al. |
| 2011/0109801 | May 2011 | Thomas et al. |
| 2011/0202956 | August 2011 | Connelly et al. |
| 2011/0206342 | August 2011 | Thompson et al. |
| 2011/0239249 | September 2011 | Murison et al. |
| 2011/0243533 | October 2011 | Stern et al. |
| 2011/0252451 | October 2011 | Turgeman et al. |
| 2011/0286721 | November 2011 | Craner |
| 2011/0289410 | November 2011 | Paczkowski |
| 2011/0293113 | December 2011 | McCarthy |
| 2012/0020641 | January 2012 | Sakaniwa et al. |
| 2012/0052941 | March 2012 | Mo |
| 2012/0060178 | March 2012 | Minakuchi et al. |
| 2012/0066722 | March 2012 | Cheung et al. |
| 2012/0106932 | May 2012 | Grevers, Jr. |
| 2012/0131613 | May 2012 | Ellis et al. |
| 2012/0185895 | July 2012 | Wong et al. |
| 2012/0204209 | August 2012 | Kubo |
| 2012/0230651 | September 2012 | Chen |
| 2012/0246672 | September 2012 | Sridhar et al. |
| 2012/0278837 | November 2012 | Curtis et al. |
| 2012/0311633 | December 2012 | Mandrekar et al. |
| 2013/0014159 | January 2013 | Wiser et al. |
| 2013/0042280 | February 2013 | Chen |
| 2013/0055304 | February 2013 | Kirby et al. |
| 2013/0061313 | March 2013 | Cullimore et al. |
| 2013/0074109 | March 2013 | Skelton et al. |
| 2013/0114940 | May 2013 | Merzon et al. |
| 2013/0128119 | May 2013 | Madathodiyil |
| 2013/0145023 | June 2013 | Li et al. |
| 2013/0174196 | July 2013 | Herlein |
| 2013/0194503 | August 2013 | Yamashita |
| 2013/0232148 | September 2013 | MacDonald et al. |
| 2013/0243398 | September 2013 | Templeman et al. |
| 2013/0263189 | October 2013 | Garner |
| 2013/0283162 | October 2013 | Aronsson |
| 2013/0298151 | November 2013 | Leske et al. |
| 2013/0332962 | December 2013 | Moritz et al. |
| 2013/0346302 | December 2013 | Purves et al. |
| 2014/0032709 | January 2014 | Saussy et al. |
| 2014/0067998 | March 2014 | Garcia et al. |
| 2014/0068675 | March 2014 | Mountain |
| 2014/0123160 | May 2014 | van Coppenolle et al. |
| 2014/0139555 | May 2014 | Levy |
| 2014/0140680 | May 2014 | Jo |
| 2014/0153904 | June 2014 | Adimatyam et al. |
| 2014/0157327 | June 2014 | Roberts et al. |
| 2014/0215539 | July 2014 | Chen et al. |
| 2014/0218517 | August 2014 | Kim et al. |
| 2014/0247931 | September 2014 | Swamy et al. |
| 2014/0282714 | September 2014 | Hussain |
| 2014/0282741 | September 2014 | Shoykhet |
| 2014/0282745 | September 2014 | Chipman et al. |
| 2014/0282759 | September 2014 | Harvey et al. |
| 2014/0294201 | October 2014 | Johnson |
| 2014/0310075 | October 2014 | Ricci |
| 2014/0310819 | October 2014 | Cakarel et al. |
| 2014/0313341 | October 2014 | Stribling |
| 2014/0325556 | October 2014 | Hoang et al. |
| 2014/0331260 | November 2014 | Gratton |
| 2014/0333841 | November 2014 | Steck |
| 2014/0351045 | November 2014 | Abihssira et al. |
| 2014/0373079 | December 2014 | Friedrich et al. |
| 2015/0003814 | January 2015 | Miller |
| 2015/0020097 | January 2015 | Freed et al. |
| 2015/0040176 | February 2015 | Hybertson et al. |
| 2015/0052568 | February 2015 | Glennon et al. |
| 2015/0054910 | February 2015 | Offen et al. |
| 2015/0058890 | February 2015 | Kapa |
| 2015/0095932 | April 2015 | Ren |
| 2015/0118992 | April 2015 | Wyatt et al. |
| 2015/0143408 | May 2015 | Sallas |
| 2015/0156612 | June 2015 | Vemaulapalli |
| 2015/0181132 | June 2015 | Kummer et al. |
| 2015/0181279 | June 2015 | Martch et al. |
| 2015/0229981 | August 2015 | Williams et al. |
| 2015/0249803 | September 2015 | Tozer et al. |
| 2015/0249864 | September 2015 | Tang et al. |
| 2015/0310725 | October 2015 | Koskan |
| 2015/0334461 | November 2015 | Yu |
| 2016/0066026 | March 2016 | Mountain |
| 2016/0066049 | March 2016 | Mountain |
| 2016/0066056 | March 2016 | Mountain |
| 2016/0073172 | March 2016 | Sharples |
| 2016/0088351 | March 2016 | Petruzzelli et al. |
| 2016/0191147 | June 2016 | Martch |
| 2016/0198229 | July 2016 | Keipert |
| 2016/0309212 | October 2016 | Martch et al. |
| 2017/0111696 | April 2017 | Petruzzelli et al. |

### REFERENCES CITED REGARDING VOLUME ADJUSTING APPARATUS AND METHOD, UNITED STATES PATENT DOCUMENTS

| | | |
|---|---|---|
| 9,936,156 | Apr. 3, 2018 | Western; Samantha |

Other references cited:

U.S. Patent Documents

| | | |
|---|---|---|
| 5,369,440 | November 1994 | Sussman |
| 6,552,753 | April 2003 | Zhurbinskiy |
| 2003/0043051 | March 2003 | Shiraishi |
| 2003/0204857 | October 2003 | Dinwiddie |
| 2009/0066855 | March 2009 | Kumano |
| 2010/0195002 | August 2010 | Chen |
| 2011/0051016 | March 2011 | Malode |
| 2011/0093882 | April 2011 | Candelore |
| 2013/0033647 | February 2013 | Yuan |
| 2016/0127675 | May 2016 | Ahn |

### FEDERALLY SPONSORED RESEARCH OR DEVELOPMENT

Not applicable. No federal sponsorship was used in the research or development of this invention.

### NAMES OF PARTIES IN JOINT RESEARCH AGREEMENT

Not applicable. No other parties were engaged in research or development related to this invention.

### REFERENCE TO “SEQUENCE LISTING”

Not applicable

### BACKGROUND OF THE INVENTION

Remote control devices for televisions, stereos and other consumer equipment typically include a mute button. This muting reduces a listener-set volume level to a zero or near-zero level. The low-level setting is not adjustable by the listener but is pre-set by the factory. Volume dials or adjustments allow the volume to be incrementally increased/decreased. The mute button described is similar to the invention, in that it toggles between two volume levels. The zero volume level cannot be adjusted, and assumes that the consumer wishes to mute the volume to zero in order to hear other activity until the mute button is pressed again. Standard manual volume dials can be rotated or adjusted to move between high volumes and low volumes. Volume up and volume down buttons can be incrementally adjusted to increase or decrease volume levels. This must be done in a step-wise fashion to incrementally increase/decrease volumes, taking longer and requiring a “hit and miss” adjustment to attempt to achieve the right sound levels.

The invention solves the basic problem presented by television shows and movies, where there are often very low volume portions which are somewhat hard to hear (e.g. conversations, quiet and suspenseful portions of entertainment) and portions of the entertainment that are very loud (explosions, chase scenes, gun fights, screaming moments, etc.). It has become a common technique in modern film and TV production to establish significant swings in volume where the viewer is forced to listen closely to quiet scenes, then be shocked by explosions, gun fights, and other very loud portions of the show. This might be generically referred to as the “Spielberg Effect”, since Steven Spielberg has used these shocking swings of volume as a critical part of his films. Such an approach to making films and TV shows is now very common.

### SUMMARY OF THE INVENTION

The invention provides a toggled audio volume button, whereby the desired high volume setting and low volume settings are pre-set by the listener, and can be toggled between. In this manner, the high volume setting can be selected for quiet scenes, and the low volume setting can be selected for noisy scenes. An additional feature of the invention is to provide an automatic volume switch, where the television or other electronic device automatically detects the loud sections and quiet sections and automatically switches between them. In this way, the loud sections are more quiet and the quiet sections are brought up in volume.

A combination of three electronic buttons is joined with the necessary software to create the desired functionality. The typical embodiment is as a remote control device for a television or other electronic equipment. The three buttons provide the controls which set the high-side volume, the low-side volume, and a toggle button which the listener uses to switch between the two volume settings. The high-side volume setting and low-side volume settings are pre-set by the listener and can be adjusted as needed and as described below. The volume up and volume down buttons interact with the toggle button to set the high and low settings, allowing the toggle button to switch between the two. The up volume button is required to set a high volume limit, which is locked in with the toggle button. The down volume button is required to set a low volume limit which is also locked in with the toggle button. The toggle button is essential for locking in the high and low volume setting, and switching between the two settings. It would be difficult to leave out the toggle button from the design if the adjustment mechanism is engaged with a pre-existing mute button, since the use of the mute button must somehow distinguish between the desire to toggle between high and low settings, and the desire to mute to zero or near zero levels.

Additional software and sensors built into the electronic devices add functionality by automatically detecting loud and quiet portions of the entertainment, and automatically adjusting the volume to compensate according to the preset adjustments. Once the desired high and low settings are established, the automated detection of volume swings engages the appropriate up-adjust or down-adjust toggle setting. The automation feature improves functionality by not requiring the manual toggling between volume settings. In the case where the toggling between high and low volumes is automated, the essential functionality is a volume sensor combined with software, which will detect volume swings and engage the appropriate toggle to adjust the volume. It is also essential that an appropriate time delay is built into the automatic toggle between settings so that it does not toggle too frequently during scenes.

The parts of the invention that already exist are a volume control (volume up button, volume down button) as is typically found in a remote control device for televisions, stereos or other electronic consumer equipment where sound is part of the entertainment and volume control is desired for best enjoyment. What is new is and innovative is the concept of a toggle button, which can switch between a high setting and a low setting for volume, custom set by the listener. Also new is the concept of detecting and automatically adjusting for loud and quiet portions of the entertainment.

Steps required to utilize the toggled volume adjustments include:
1. Set the volume up setting to desired high volume level. This should be done during the more quiet portions of the entertainment, to enable easier hearing of these quiet sections.
2. Press the toggle button once briefly. This pre-sets the higher volume setting.
3. Set the volume down setting to desired low volume level. This should be done during the more loud portions of the entertainment, to lower the impact of noisy portions of the entertainment.
4. Press the toggle button once again briefly. This pre-sets the lower volume setting.
5. To manually toggle between the high and low volume settings as needed, press the middle toggle button alternately. This engages the pre-set high and low settings alternately each time the button is pressed.
6. To re-set the toggle button, press and hold the middle toggle button for a longer period, say three or more seconds.
7. To set for automatic detection of high/low volume changes and compensate by toggling to high or low volume pre-sets, press the automatic button. This engages the automatic detection and adjustment mechanism and software. Sound levels are then automatically detected and toggled between high and low settings as described.
8. Press the automatic button again to release the automated button and enable manual toggling between pre-set volume settings.

As alternatives, the buttons and adjustments could be placed directly on the control panel of the electronic device (TV, stereo, etc), rather than or in addition to placement on a remote control device. The toggle buttons could be replaced with a toggle switch, dial, rocker switch or other similar electronic switching device. These buttons and adjustments could also be represented by software icons on-screen and engaged using a pointer, mouse or other such device. Additionally, the functionality could be changed by adding the functionality to software and imbedding it in the on-screen, software controlled functions. Volume and toggle buttons could also be replaced with switches, rocker switches, dials, or other similar electronic devices.

The functionality might also be build into any media equipment, for example:
Teleconferencing equipment where volume swings due to various multi-site participants render it difficult to hear some portions, and render others too loud.
Telephonic devices where it is desired to adjust volumes up or down between pre-set high and low volume settings.
Hearing aids where the described controls are on the device, or on a personal device like a phone, electronic pad or computer which is linked to the hearing aid via blue-tooth or other means.
Theater presentations where adjustments are desired between loud and quiet sections of entertainment.
Music concerts or other such presentations where it is desired to adjust volumes between lower and higher settings for various reasons.
Automobiles where it is useful to be able to reduce volumes at times (for example where it desired to talk, hear sirens or other events on the road) and then increase volumes to pre-set desired levels.
Personal music devices where at times it is necessary to lower volumes for conversation or hearing, and then adjust to high pre-set volume when desired.
Personal computers or electronic pads for playing video, music or sounds, where volume adjustments can be built into sound management software in the manner described here.
Music headsets could include the described volume toggling switches, where the described controls are on the device, or on a personal device like a phone, electronic pad or computer which is linked to the headset via blue-tooth or other means.

### DESCRIPTION OF THE SEVERAL VIEWS OF THE DRAWINGS

### Remote Control Audio Volume Toggle Switches

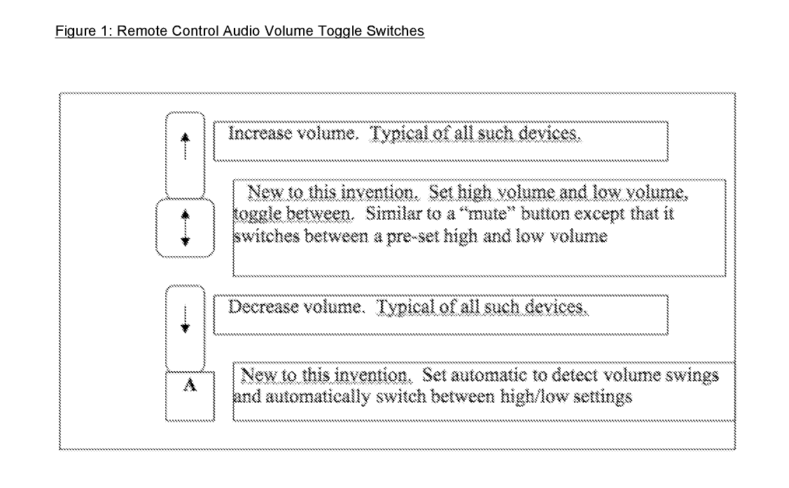

FIG. 1 displays the arrangement of volume up button, volume down button, the toggle switch between high and low volume settings, and the automated volume control button

1. Preset high-side and low-side volume settings, which are set by the listener as a customized range for loud and soft portions of audio entertainment as described herein. The hi-side setting is established by the listener during the softer portions of the programming, where it is desirable to increase the audio volume. The low-side volume setting is established by the listener during the louder portions of the programming, where it is desirable to reduce the audio volume. These high-side and low-side settings are “remembered”, or programmed into the remote control or other device once customized by the listener as described. These settings can also be erased and reset as needed. The programming of these listener settings can be stored in a remote control or other device.

2. A toggle switch or button which alternates between the high-side and low-side settings described above and in this invention. The toggle is pressed or otherwise engaged by the listener to switch to louder or softer sound levels as needed, alternating each time the toggle switch or button is briefly engaged. The toggle switch or button is also used as the reset mechanism by pressing for longer periods than the brief toggle switch pressing. After this reset, the high-side and low-side settings can be reestablished.

3. An automatic setting to detect high audio volume (which triggers toggle to low-side volume setting) and low audio volumes (which triggers toggle to high-side volume settings). This automatic setting is engaged by a detector in the remote control unit or other device, which is programmed to determine that the sound volumes are either too loud or above the preset sound range (which will cause an automatic toggle to the preset low-side volume setting) or too soft or below the preset sound range (which will cause an automatic toggle to the preset high-side volume setting).
Many features have been listed with particular configurations, options, and embodiments. Any one or more of the features described may be added to or combined with any of the other embodiments or other standard devices to create alternate combinations and embodiments. Therefore, it is noted that various preferred embodiments of the present invention employ differing combinations of the optional and necessary components of the present invention.
Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.
